(19) United States
(12) Patent Application Publication
(10) Pub. No.: US 2008/0244866 A1
(43) Pub. Date: Oct. 9, 2008

(54) Special improved adjustable hinge device

(76) Inventor: Michael W. Stanley, Muncie, IN (US)

Correspondence Address: RITCHISON LAW OFFICES, PC, 115 EAST NINTH STREET - SUITE A, ANDERSON, IN, 46016-1507, US

(21) Appl. No.: 12/082,009

(22) Filed: Apr. 8, 2008

Related U.S. Application Data
(60) Provisional application No. 60/922,472, filed on Apr. 9, 2007.

(51) Int. Cl. E05D 7/04

(52) U.S. Cl. 16/238; 16/236

(57) ABSTRACT

This is an improved hinge device with unique adjustable features. Particularly this hinge device is used to aid in the adjustment and fitting of existing doors in buildings and in the initial installation of doors into buildings and may be incorporated in combination with other types of door hinge devices where easy adjustment for fit is desired or required. The preferred embodiment is comprised of a simple adjustable top and bottom hinge assemblies with unique connection features and a special middle adjustable hinge 33 with unique adjustable features for vertical and rotational alignment.

### CROSS-REFERENCE TO RELATED APPLICATIONS

This application claims the benefit of Provisional Patent Application Ser. No. 60/922,472 filed Apr. 9, 2007 by Michael W. Stanley and entitled “SPECIAL IMPROVED TABLE HINGE DEVICE”.

### FIELD OF INVENTION

This invention relates to a special improvement including adjustable features for a hinge device. Particularly this hinge device is related to those devices used to aid in the adjustment and fitting of existing doors in buildings and in the initial installation of doors into buildings. This special hinge device and system called a SPECIAL IMPROVED ADJUSTABLE HINGE DEVICE may be incorporated in combination with other types of door hinge devices where easy adjustment for fitting the door to the jamb is desired or required.

### FEDERALLY SPONSORED RESEARCH

None.

### SEQUENCE LISTING OR PROGRAM

None.

### BACKGROUND—FIELD OF INVENTION

The new special hinge device and system called a SPECIAL IMPROVED ADJUSTABLE HINGE DEVICE is a product and system that is designed to provide an improved hinge system for door, cabinets, and other objects that need a hinged lea door. Particularly this special hinge is secured by an adjustable pin system to the swivel loop on the pivoting plate. One skilled in the art of hinges and hinge devices will appreciate the plethora and varied uses anticipated by this new special adjustable hinge device.

A. Introduction of the Problems Addressed

The standard hinge systems for doors are lacking in adjustments for vertical location and rotational location. Prior art has a few complex devices that address one or the other adjustments (vertical or rotational). None address both. Or new installations and retrofits for refurbishments to houses and commercial buildings, it is desired to have one simple system that accomplishes both vertical and rotational adjustments for doors.

B. Prior Art

Prior art begins with a U.S. Pat. No. 880,317 issued to Von de Marwitz (1908) teaches a rotational adjustable hinge with a base plate and adjusting bolt/screw. It teaches only one adjustment for a door hinge and is not the complete system taught by the current application. Other examples of an adjustable hinge continues with U.S. Pat. No. 1,440,713 issued to Ausborne (1923) which teaches a device with a vertical adjustment with a threaded hinge pin and lock nut. No rotational adjustment is taught.

Another vertically adjusting hinge device with a threaded pin is taught by the U.S. Pat. No. 1,465,912 issued to Jensen (1923). The patent taught a short threaded portion of a hinge pin that connected to the remaining hinge device. No rotational adjustment is taught. A U.S. Pat. No. 2,779,966 issued to Torchia (1953) was focused on a vertical adjusting hinge with a set screw to lock the device into place. Again, no rotational adjustment is taught.

A further invention is taught by the U.S. Pat. No. 4,825,507 issued to Killingstad (1989). Here an awkward and complex rotational adjusting hinge is taught. No accompanying vertical adjustment is included. A U.S. Pat. No. 5,555,605 issued to Mosher (1996) was focused on a rotational adjusting hinge. Only one adjustment was shown so the operation is erratic at best. No vertical adjustment is taught.

Still another vertically adjusting hinge device with a threaded pin is taught by the U.S. Pat. No. 5,933,919 issued to Miller et al (1999). The patent taught a longer, completely threaded hinge pin that connected to the remaining hinge device. No rotational adjustment is taught. Finally, a U.S. Pat. No. 6,158,086 issued to De Souza (2000) was focused on a rotational adjusting hinge. Again, no vertical adjustment is taught.

As far as known, there are no hinge devices at the present time which fully meet this need with as few components and superior operation as the present SPECIAL IMPROVED ADJUSTABLE HINGE DEVICE. It is believed that this device is made with fewer parts, of a more durable design, and with much improved capabilities than any previous adjustable hinge or combination hinge assembly.

### SUMMARY OF THE INVENTION

A SPECIAL IMPROVED ADJUSTABLE HINGE DEVICE has been developed for use by a person to easily add to a new or existing door and jamb assembly. A person normally has to replace a door and reset a door jamb when it becomes too difficult to open and close because of the warped or deformed condition. Likewise, new door installations may benefit from a system that provides easy adjustment features. The improved SPECIAL IMPROVED ADJUSTABLE HINGE DEVICE permits the installation and adjustment for both new and replacement doors. Specifically, the SPECIAL IMPROVED ADJUSTABLE HINGE DEVICE provides a better way to support and adjust the door mounting through easily adjustable hinges.

The preferred embodiment of the device is comprised of a simple adjustable top and bottom hinge assembly with unique features and a middle adjustable hinge with other adjustable features. Other features and variations may be realized with simple changes to the preferred configuration. This SPECIAL IMPROVED ADJUSTABLE HINGE DEVICE is potentially made of various materials and is designed for Original door installations or for a retrofit addition to currently used door systems.

The newly invented SPECIAL IMPROVED ADJUSTABLE HINGE DEVICE may be easily produced by various manufacturing processes depending on the material and configuration desired. In operation, the new SPECIAL IMPROVED ADJUSTABLE HINGE DEVICE may be put into use without the need of any special tools or fasteners and provides simple and easy adjustment as described in detail below.

### OBJECTS AND ADVANTAGES

There are several objects and advantages of the SPECIAL IMPROVED ADJUSTABLE HINGE DEVICE. There are currently no known adjustable hinge devices that are effective at providing all or even most of the objects of this invention.

One advantage and object of the present invention is that it provides easy installation and adjustment to the door assembly. The hinges are similar other door but have unique adjustment features. This device enables a person to easily adjust and set a door for near perfect operation.

Another object for the SPECIAL IMPROVED ADJUSTABLE HINGE DEVICE is to provide a device that may be installed and adjusted with simple hand tools. This means special tools and skills are not needed to gain the advantage of this easily adjusted SPECIAL IMPROVED ADJUSTABLE HINGE DEVICE.

There has been another object of the present invention which is to be versatile as to size. This same concept may be used for different sized doors from pedestrian, cabinet and other swinging doors mounted with leaf hinges.

A further advantaged offered with the SPECIAL IMPROVED ADJUSTABLE HINGE DEVICE is that it is designed for simplicity. By using a non-complex design, this simplicity also permits an inexpensive process to manufacture and allows for a less expensive cost to ultimately produce. The top, middle and bottom hinges use many of the same base parts.

Finally, other advantages and additional features of the present SPECIAL IMPROVED ADJUSTABLE HINGE DEVICE will be more apparent from the accompanying drawings and from the full description of the device. For one skilled in the art of hinge devices and improvements, it is readily understood that the features shown in the examples with this mechanism are readily adapted to other types of hinge device improvements.

### DESCRIPTION OF THE DRAWINGS—FIGURES

The accompanying drawings, which are incorporated in and constitute a part of this specification, illustrate an embodiment of the SPECIAL IMPROVED ADJUSTABLE HINGE DEVICE that is preferred. The drawings together with the summary description given above and a detailed description given below serve to explain the principles of the SPECIAL IMPROVED ADJUSTABLE HINGE DEVICE. It is understood, however, that the SPECIAL IMPROVED ADJUSTABLE HINGE DEVICE is not limited to only the precise arrangements and instrumentalities shown.

FIG. 1 is a sketch of the general SPECIAL IMPROVED ADJUSTABLE HINGE DEVICE.

FIG. 2 are sketches of the prototype SPECIAL IMPROVED ADJUSTABLE HINGE DEVICE

FIG. 3 are sketches of the adjustable hinge assembly details.

FIG. 4 are sketches of the adjustable plate assembly details.

FIG. 5 are sketches of the base plate details.

FIG. 6 are sketches of the typical hinge pin details.

FIG. 7 are sketches of the adjustable screw/bolt details.

FIG. 8 are sketches of the swivel plate details.

FIG. 9 are sketches of the Mid swivel assembly details.

FIG. 10 are sketches of the prototype of the Mid swivel threaded pin.

FIG. 11 show Mid swivel assembly sketches.

FIG. 12 are sketches of the Mid swivel threaded pin details.

FIG. 13 are sketches of the Mid swivel end fastener details.

FIG. 14 are sketches of the Mid swivel plate details.

### DESCRIPTION OF THE DRAWINGS—REFERENCE NUMERALS

The following list refers to the drawings:

| | |
|---|---|
| 31 | General view of the SPECIAL IMPROVED ADJUSTABLE HINGE DEVICE |
| 32 | Adjustable hinge assembly - top hinge |
| 32A | Adjustable hinge assembly - bottom hinge |
| 33 | Mid swivel hinge assembly |
| 34 | Proto-type of the SPECIAL IMPROVED ADJUSTABLE HINGE DEVICE |
| 35 | Close up sketch of the Adjustable hinge assembly |
| 36 | Fastening and securing means such as Lock nuts or the |
| | equivalent |
| 37 | Hinge plate loop |
| 38 | Typical hinge pin |
| 38A | Hinge pin head |
| 39 | Swivel plate |
| 39A | Relief aperture |
| 39B | Mounting means aperture (space to mount mounting fastener |
| | such as a wood screw or the like) |
| 40 | Adjusting screw/bolt |
| 40A | Headed turning means such as an internal hex or the like |
| 40B | Externally threaded shaft |
| 40C | Flat, smooth end plated of the screw/bold |
| 41 | Base plate |
| 41A | Mounting aperture |
| 41B | Means to fasten aperture |
| 41C | Plate step for adjusting screw (40) retention by plate |
| 42 | Adjustable plate |
| 43 | Door jamb |
| 44 | mid swivel plate |
| 45 | Door |
| 46 | Threaded aperture |
| 47 | Through aperture to mount fastening means |
| 48 | Mid swivel threaded pin |
| 48A | End fastener for Mid swivel threaded pin |
| 48AA | Turning head means such as an internal hex or the like |
| 48AB | Internal threads |
| 49 | Insert with internal threaded fastener |
| 49A | Alternative threaded hinge plate loop |
| 49B | Internal threads |
| 50 | Set screw threaded receiver aperture in the Mid swivel |
| | threaded pin |
| 51 | Gap between the Mid swivel threaded pin and the Base plate |
| 51A | No-Gap between the Mid swivel threaded pin and the Base plate |

### DETAILED DESCRIPTION OF PREFERRED EMBODIMENT

The present device is a mechanism for a person to assist in the adjustment and fit of a door through the use of the SPECIAL IMPROVED ADJUSTABLE HINGE DEVICE 31. The preferred embodiment of the device is comprised of a simple adjustable top and bottom hinge assembly with unique features and a middle adjustable hinge with other adjustable features. Other features and variations may be realized with simple changes to the preferred configuration. Other features may be built into the device and are explained below. The SPECIAL IMPROVED ADJUSTABLE HINGE DEVICE 31 is potentially made of various materials and is designed for Original Door installations or Retrofit to existing door systems. The device may have alternatives embodiment with various materials and configurations. A person having ordinary skill in the field of door mountings and hinges such as shown here appreciates the various materials and configurations that are within the scope and spirit of this SPECIAL IMPROVED ADJUSTABLE HINGE DEVICE 31.

The improvement over the existing art is providing a device that:
a. has easy installation and adjustment;
b. may be installed and adjusted with simple hand tools;
c. is versatile as to size;
d. is designed for simplicity; and
e. has a less expensive cost.

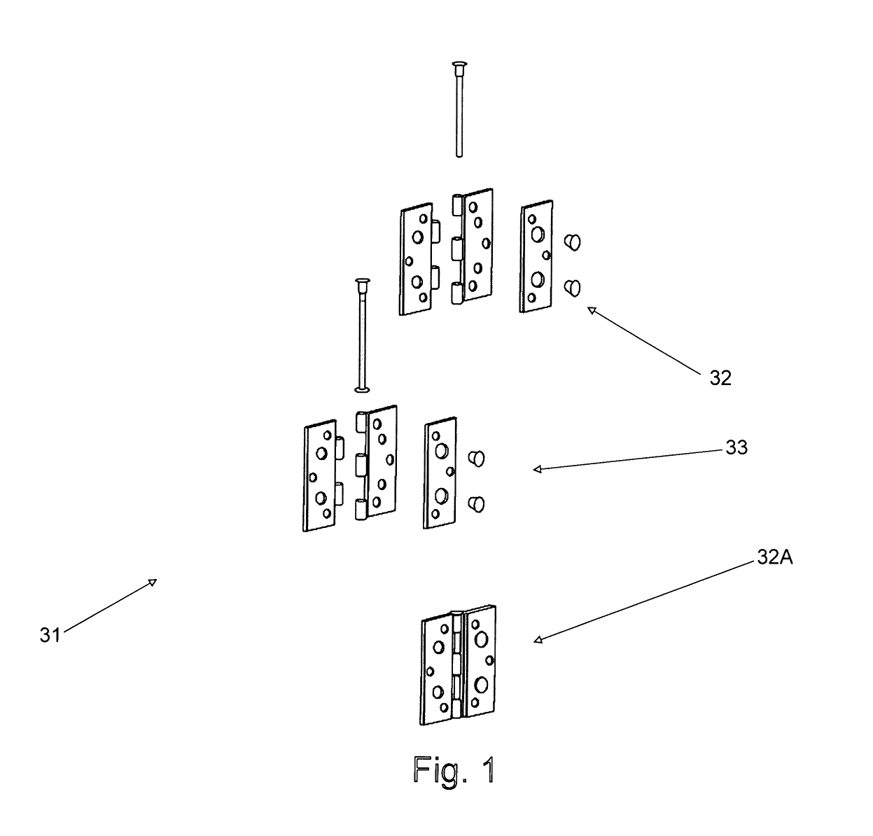

There is shown in FIGS. 1-14 a complete operative embodiment of the SPECIAL IMPROVED ADJUSTABLE HINGE DEVICE 31. In the drawings and illustrations, one notes well that the FIGS. 1-14 demonstrate the general configuration and use of this invention. The preferred embodiment of the device is comprised of a simple adjustable top and bottom hinge assembly with unique features and a middle adjustable hinge with other adjustable features. Other features and variations may be realized with simple changes to the preferred configuration and are described below. These various important features are described below in appropriate detail for one skilled in the art to appreciate their importance and functionality to the SPECIAL IMPROVED ADJUSTABLE HINGE DEVICE 31.

The accompanying drawings, which are incorporated in and constitute a part of this specification, illustrate an embodiment of the SPECIAL IMPROVED ADJUSTABLE HINGE DEVICE 31 that is preferred. The drawings together with the summary description given above and a detailed description given below serve to explain the principles of the SPECIAL IMPROVED ADJUSTABLE HINGE DEVICE 31. It is understood, however, that the SPECIAL IMPROVED ADJUSTABLE HINGE DEVICE 31 is not limited to only the precise arrangements and instrumentalities shown.

FIG. 1 is a sketch of the general SPECIAL IMPROVED ADJUSTABLE HINGE DEVICE 31. The preferred embodiment of the device 31 is comprised of a simple adjustable top 32 and bottom 32A hinge assembly with unique features and a middle adjustable hinge 33 with other adjustable features. The component parts are shown in other figures and described below. As one skilled in hinge devices appreciates, there is a plethora of materials suitable to make the hinge components. As for example, and not a limitation to the scope and spirit of the device, the material may be a metal such as steel, stainless steel, brass, copper, aluminum and the like or a composite material such as a pure plastic or reinforced plastic such as Polyamides like a nylon, Polypropylenes, Poly(vinyl chloride), Polyurethanes, or the like. The metals and composites may also have a surface treatment or coating for corrosion and wear resistance such as a plating, paint or powder coat material.

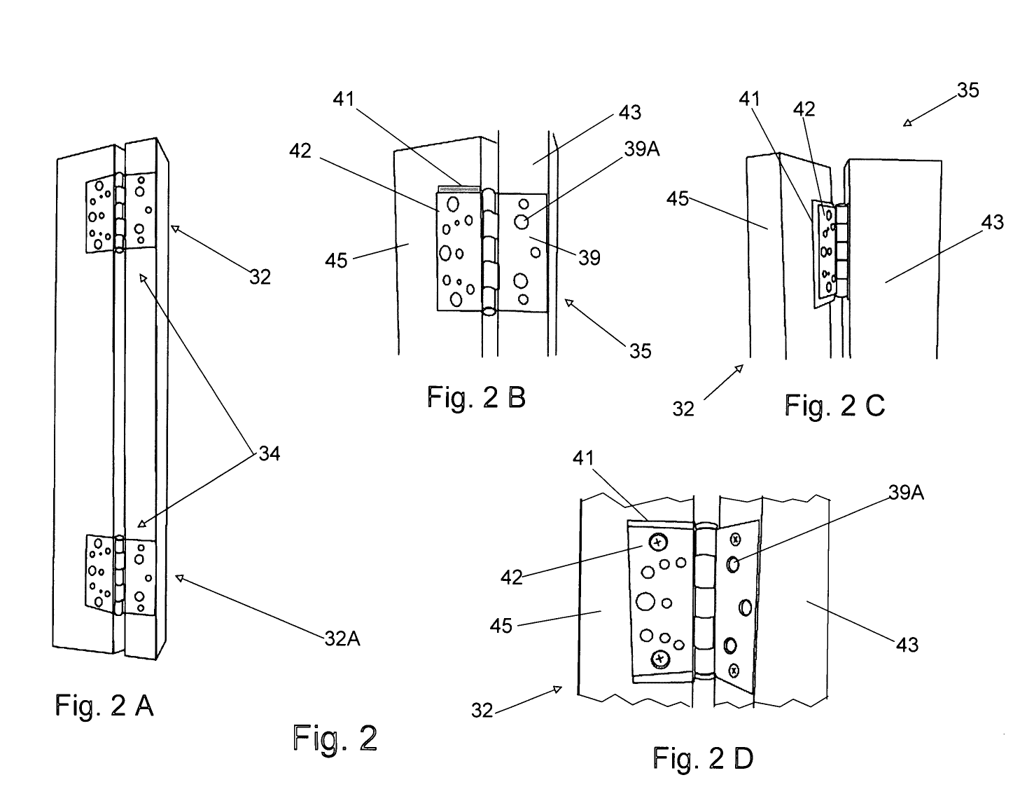

FIG. 2 are sketches of the prototype SPECIAL IMPROVED ADJUSTABLE HINGE DEVICE 31. The Proto-type 34 of the SPECIAL IMPROVED ADJUSTABLE HINGE DEVICE 31 consists of standard hinges that have been modified to simulate the adjustable hinge assembly—top hinge 32 and bottom hinge 32A as shown in FIG. 2A. Close up sketch 35 of the Adjustable hinge assembly 32, 32A are shown in the balance of FIGS. 2B through 2D. In the close-ups, the wood 2×4's represents a door 45 and door jamb 43. The Swivel plate 39 is shown in various positions as the door 45 swings. The base plate 41 and the Adjustable plate 42 are also shown in each position. The adjustment screws 40 are not as readily seen but are described below. The relief hole 39A for the screws 40 are shown in the simulated jamb 43.

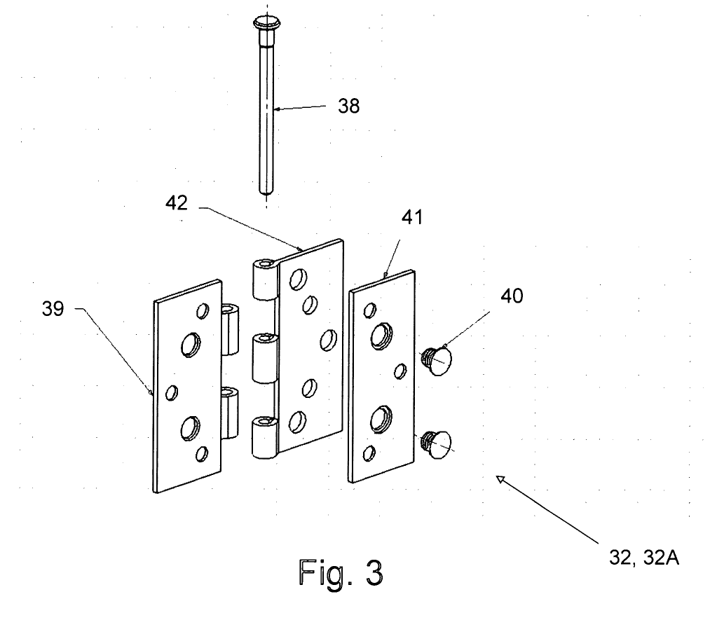

FIG. 3 is an isometric sketch with details of the adjustable hinge assembly 32, 32A. The Swivel plate 39, Base plate 41, Adjustable plate 42 and adjustment screws 40 are all shown. Also, the typical hinge pin 38 is provided to show how the Adjustable hinge assembly—top hinge 32, 32A is assembled.

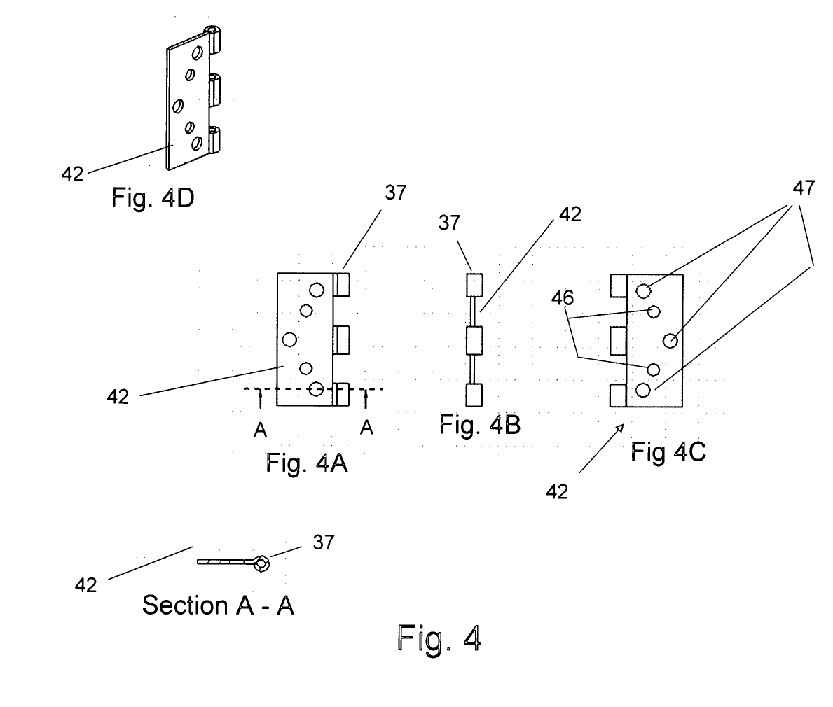

FIG. 4 are sketches of the adjustable plate 42 assembly details. FIG. 4A is a Front View, FIG. 4B is a Side View, FIG. 4C is a Back View and FIG. 4D is an Isometric View of the adjustable plate 42 with its features. Section A-A is a section view of the adjustable plate 42. The plate 42 consists of a thin and flat, rectangular sheet or plate with Hinge plate loops 37 formed with the sheet. The plate area have Threaded apertures 46 to accept and engage with the adjusting screw 40 (not shown). The plate also has a plurality of Through apertures 47 to permit the base plate 39 (not shown) to be mounted to the door 45 by a fastening means.

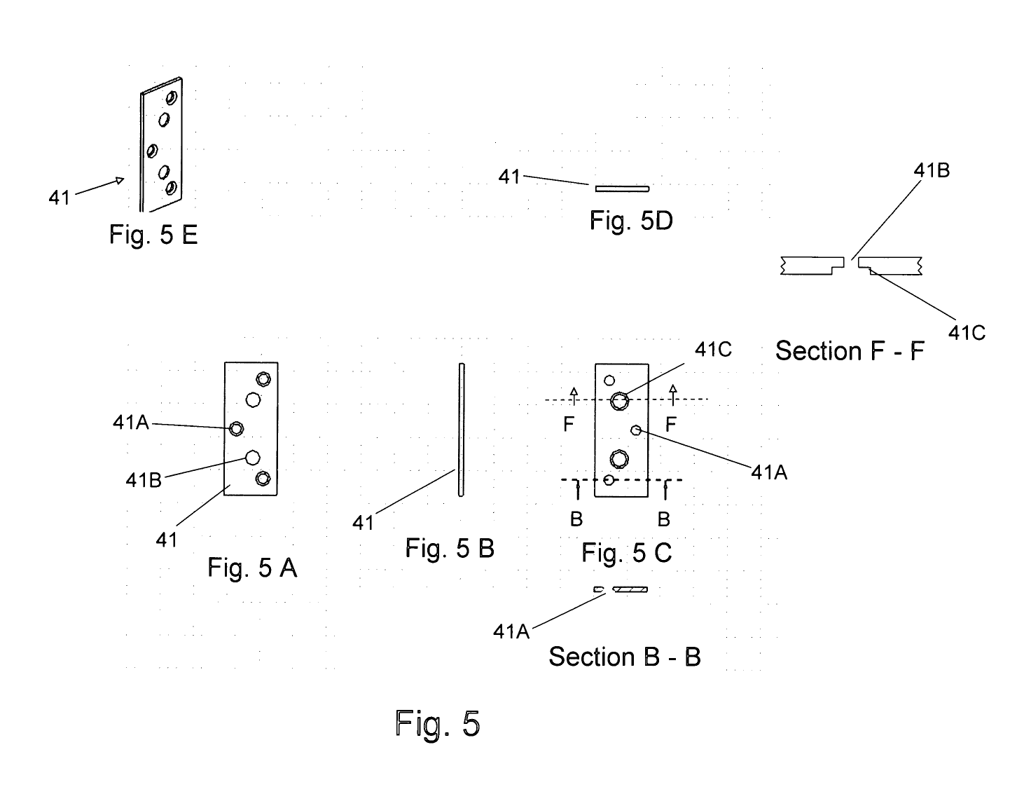

FIG. 5 are sketches of the details of the base plate 41. FIG. 5A is a Front View, FIG. 5B is a Side View, FIG. 5C is a Back View and FIG. 5D is and End View. FIG. 5E is an Isometric View of the base plate 41 with its features. The plate 41 is essentially rectangular in shape. The base plate 41 is mounted to the door by means of a plurality of mounting apertures 41A. These accept normally fasteners such as wood screws, bolts or the like. These fasteners extend through the plate 41 in the void created as an aperture 41B to accept the fastening means. As a special feature, the back or surface of the plate 41 that is placed contiguous to the door 45 has a step feature 41C. The screw 40 is placed through the aperture 41B and held rotatably by the step means 41C.

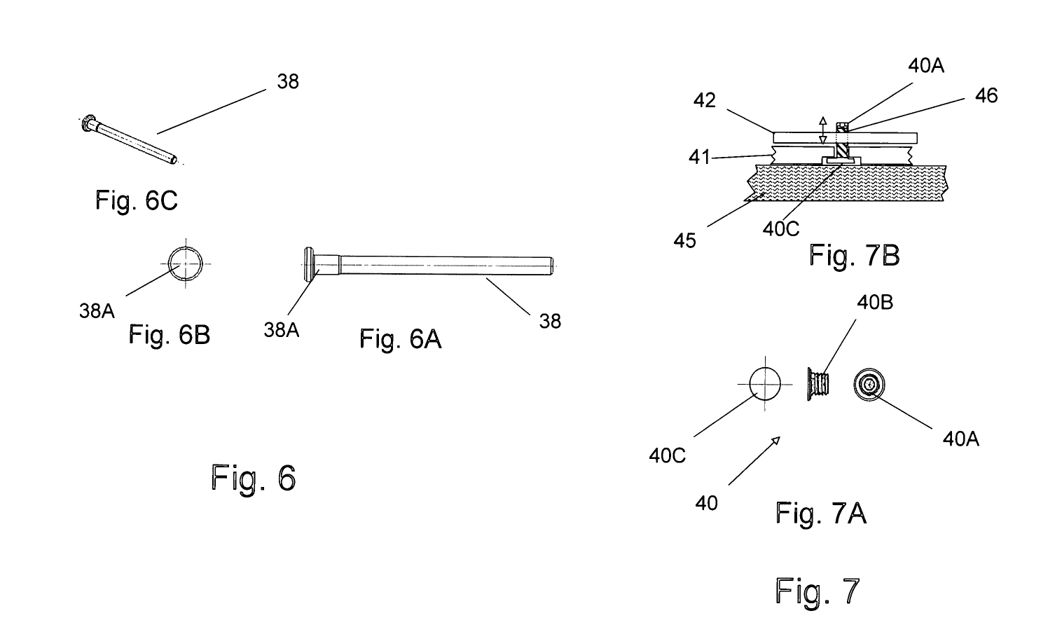

FIG. 6 are sketches of the details for a typical hinge pin 38. FIG. 6A is a Side View, FIG. 6B is an End View, and FIG. 6C is an Isometric View of the typical hinge pin 38 with its features. The smooth, thin shaft of the pin 38 has a formed head 38A at one end for assembly and a slight taper at the opposite end for ease of insertion into the hinge loops 37.

FIGS. 7A and B are sketches of the adjustable screw/bolt 40 details. Details in FIG. 7A show the adjusting screw/bolt fastener 40 which has one shaft and end 41B which is an externally threaded shaft. The end of the threaded shaft 41B ha a means to turn 41A such as a screw slot or an internal or external hex shape. The opposite end is a flat, smooth end plate formed integrally as part of the screw/bolt 40. In FIG. 7B, the operation is described below.

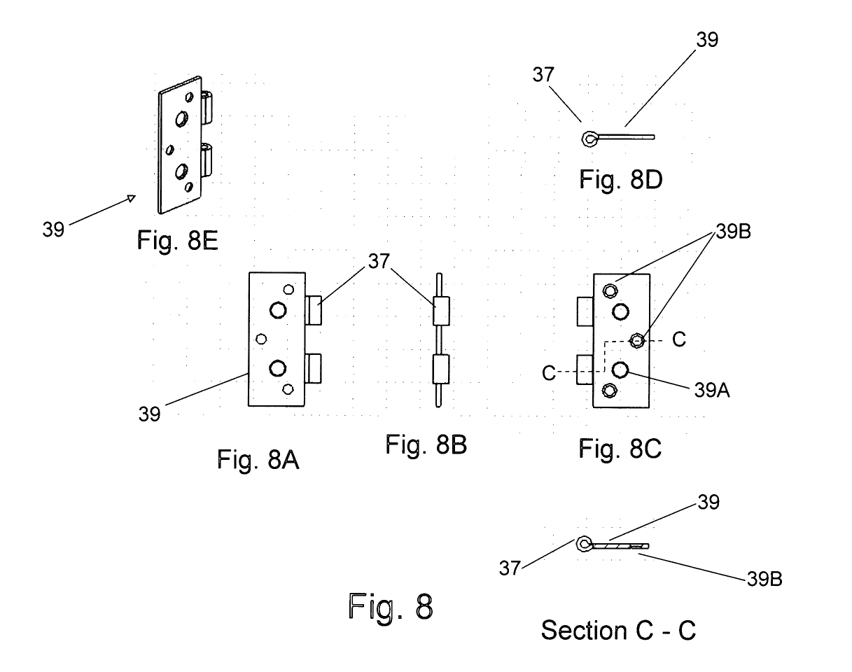

FIG. 8 are details of the swivel plate 39. FIG. 8A is a Front View, FIG. 8B is a Side View, FIG. 8C is a Back View and FIG. 8D is an End View of the swivel plate 39. FIG. 8E is an Isometric View of the swivel plate 39 with its features. The swivel plate 39 is essentially rectangular with hinge loops 37 similar to ones on the adjustable plate 42. The swivel plate is attached to the jamb 43 by a fastening means such as a bolt or wood screw. The fastener passes through the swivel plate 39 in the through aperture 39B.

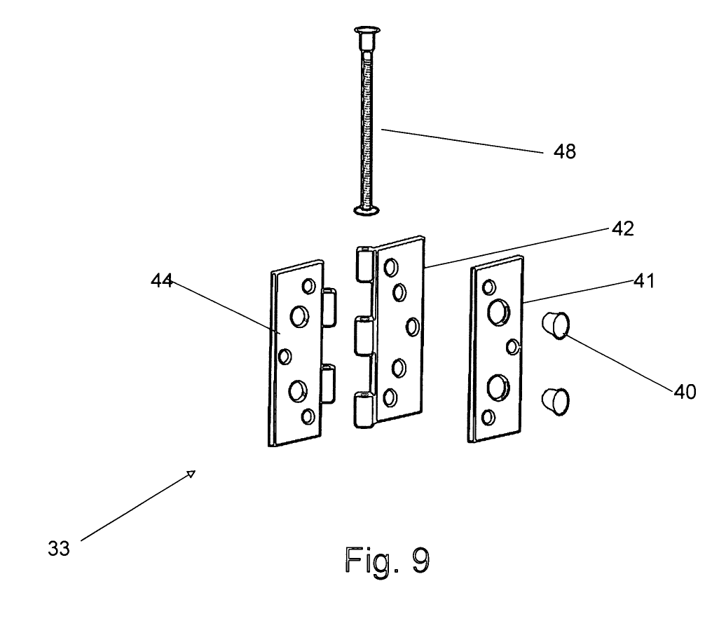

FIG. 9 is an isometric sketch of the assembly detail for the Mid swivel assembly 33. It too has a base plate 39, adjusting screws 40, and adjustable plate 42 which are similar to the top and bottom adjustable hinge assemblies 32, 32A described above. It has a different mid swivel plate 44 with different adjustment features as described below. The other major difference is the threaded pin 48 used as part of the adjustment means.

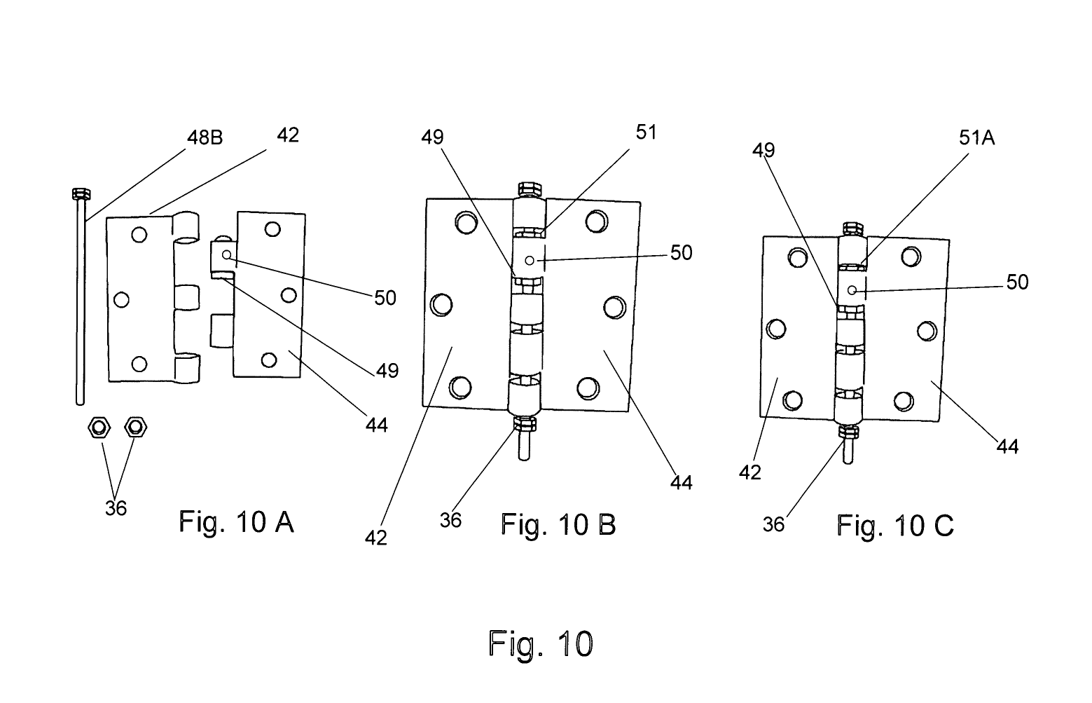

FIG. 10 are sketches of the prototype of the Mid swivel 33 with the threaded pin 48. The description and operation is described below.

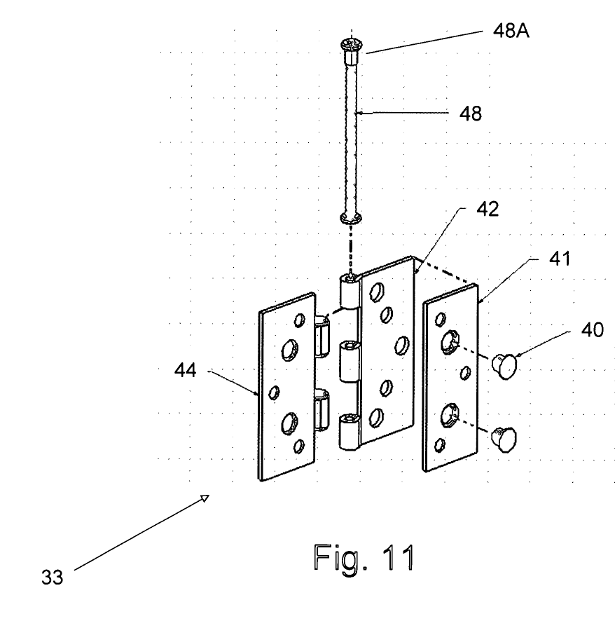

FIG. 11 shows an isometric sketch of the Mid swivel assembly 33. The component parts are the same as described above and below.

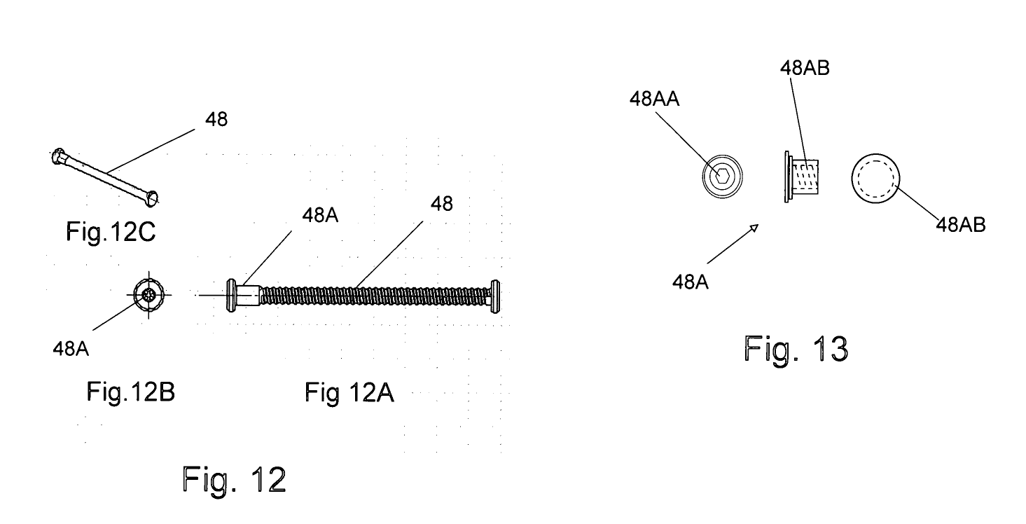

FIG. 12 are sketches with details of the Mid swivel threaded pin 48. FIG. 12A is a Side View, FIG. 12B is an End and FIG. 12C is an Isometric View of the Mid swivel threaded pin 48 with its features. The pin 48 is threaded the entire length and has a headed end with a turning feature 48AA such as an internal hexagon. At the opposite end, the pin 48 is simply threaded but securely assembles to an internally threaded fastener 48A with a similar turning means 48AA.

FIG. 13 are sketches of the details of the Mid swivel end fastener 48A. The fastener has an internal thread 48AB to engage the threaded pin 48. The fastener 48A, opposite end to the internal threads has a turning means 48AA such as an internal hex or a screw slot or equal.

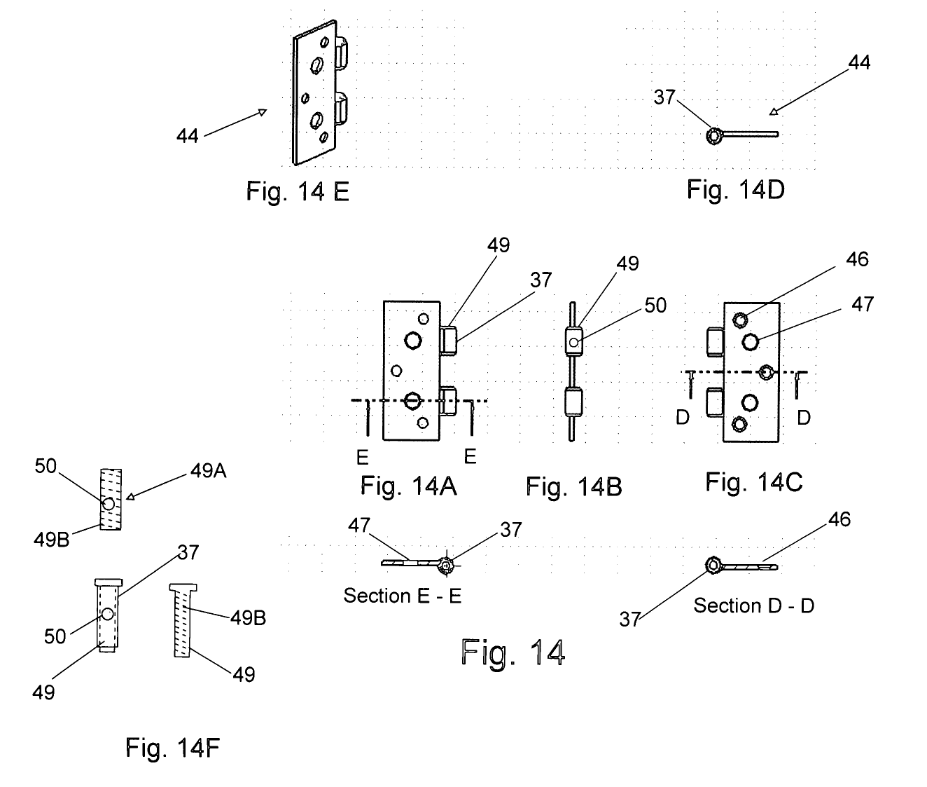

FIG. 14 are sketches of the details of the Mid swivel plate 44. FIG. 14A is a Front View, FIG. 14B is a Side View, FIG. 14C is a Back View and FIG. 14D is an End View of the Mid swivel plate 44. FIG. 12E is an Isometric View of the Mid swivel plate 44 with its features. FIG. 14F are details of the threaded insert 49 and alternative threaded loop 49A for the Mid swivel plate 44. It is essentially another rectangular plate with hinge loops 37. The plate 44 has mounting holes 46 and through holes 47. These are unique features to permit vertical adjustments of a door 45 come with the addition of one or more inserts 49. The insert has internal threads 49B to engage the threaded pin 48. It also has a fastening means 50 such as a set screw aperture and set screw to engage and secure the internal threaded insert to the hinge loop 37. Once in place and adjusted, the hinge loop is secured to the threaded through pin by means of a set screw 50 or equal. The alternative to the insert is a threaded loop 49A. Here the loop 37 is internally threaded, then provided a fastening means 50 as described above. One skilled in the art of fattener well appreciates the other variety of options to accomplish this adjustable feature. The threaded insert may be press fit, may be fitted in place by an adhesive such as a Locktite™ product or the like, or may have an external thread and locking cap nut. Other means to secure the loop are within the scope and spirit of this application.

The details mentioned here are exemplary and not limiting. Other specific components specific to describing a SPECIAL IMPROVED ADJUSTABLE HINGE DEVICE 31 may be added as a person having ordinary skill in the field of door mounting and hinge devices well appreciates.

### Operation of the Preferred Embodiment

The new SPECIAL IMPROVED ADJUSTABLE HINGE DEVICE 31 has been described in the above embodiment. The manner of how the device operates is described below. One notes well that the description above and the operation described here must be taken together to fully illustrate the concept of the SPECIAL IMPROVED ADJUSTABLE HINGE DEVICE 31.

FIG. 2 are sketches of the prototype SPECIAL IMPROVED ADJUSTABLE HINGE DEVICE 31. The top and bottom adjustable hinge assemblies 32, 32A are adjustable with the screws 40. By adjusting the screws 40, the overall door assembly may be adjusted rotationally to permit easy new door adjustments. Likewise for buildings where settlement has occurred, the door jambs 43 may shift and essentially act like a sagging parallelogram. The adjustment with this new SPECIAL IMPROVED ADJUSTABLE HINGE DEVICE 31 often required significant trimming to the door 45 or replacement of the jamb 43. The mid swivel hinge 33 is a vertical adjustment and is described below.

In FIG. 7B, the operation is described. Here the fasteners 40 extend through the plate 41 in the void created as an aperture 41B to accept the fastening means, a threaded aperture 46 in the adjustable plate. As a special feature, the back or surface of the plate 41 that is placed contiguous to the door 45 has a step feature 41C. The screw 40 is placed through the aperture 41B and held rotatably by the step means 41C. This permits the screw 40 to be rotated and engage with the adjustable plate 42 in the threaded aperture 46. As the screw is turned, the adjustable plate 42 moves toward or away form the base.

FIGS. 10A through C are prototype sketches of the Mid swivel 33 with the threaded pin 48. Here the pin 48 is held securely at the top and bottom of the pin 48 by engaging the fastener 48A. The pin 48 may rotate and turn, but is secure in the vertical position and in the hinge loops 37. The vertical adjustments of the door 45 occur by means of at least one insert 49 or alternative 49A that is secured to the hinge loop 37 by the fastening feature 50. The insert has internal threads 49B which engage the external threads of the mid pin 48. As the pin 48 is turned, the insert (secured to the hinge loop 37) moves up and down. This action raises or lowers the door. The action is demonstrated in FIG. 10B by the open gap 51 and in FIG. 10C with the closed gap 51A as the hinge moves and vertically moves the door 45. Empirical testing proves the usefulness and capability of one pin 48 and one or more inserts raising and lowering the door 45 vertically. Once in place, the pin 48 is removably secured by a fastening means 50 such as set screws or the like or by another fastening means such as lock nuts 36 or the like.

The use and operation of the SPECIAL IMPROVED ADJUSTABLE HINGE DEVICE 31 is very simple. The base plates 41 are mounted with fasteners to the door 45 as well as the adjusting plates 42 (with the screw 40) mounted to the base plates 41. The swivel plates 42 for the Adjustable hinge assembly 32, 32A and the mid swivel plate 44 for the mid swivel hinge assembly 33 are mounted to the jambs 43. This is true for new assemblies or replacement/retrofit assemblies. Once attached, adjustments are made simply. The combination of the adjusting screws 40 coupled to the base plates 41 and adjusting plates 42, a door 45 may be rotationally adjusted. By turning the threaded pin 48 of the mid swivel assembly 33, the door may be adjusted vertically.

With this description it is to be understood that the SPECIAL IMPROVED ADJUSTABLE HINGE DEVICE 31 is not to be limited to only the disclosed embodiment. The features of the SPECIAL IMPROVED ADJUSTABLE HINGE DEVICE 31 are intended to cover various modifications and equivalent arrangements included within the spirit and scope of the description.

1. An adjustable door hinge system made of durable materials for mounting a door to a door jamb comprised of:
A) a simple top adjustable hinge assembly with adjustable features
B) a simple bottom adjustable hinge assembly with adjustable features;
C) a middle swivel hinge assembly with other adjustable features; and
D) a means to connect the hinge assemblies to the door and the door jamb
whereby the unique features of the hinges permit the door to be rotationally and vertically adjusted within the door jamb to permit smooth and easy operation of the door.

2. The system according to claim 1 wherein the durable material has a surface treatment.

3. The system according to claim 2 wherein the surface treatment is plating.

4. The system according to claim 2 wherein the surface treatment is powder coat.

5. The system according to claim 2 wherein the surface treatment is paint.

6. The system according to claim 1 wherein the durable material is a metal.

7. The system according to claim 1 wherein the durable material is a composite material.

8. The system according to claim 1 wherein the adjustable feature for the top and bottom adjustable hinge assemblies is comprised of:
a) a base plate with a means to attach to the door jamb and
b) a two part hinged adjustable assembly of essentially two rectangular plates and each with a series of loops for a pin; the first plate with a means to attach to the door; the second plate with a means to adjustably attach to the base plate; and the two plates rotationally connected by the hinge plate loops and a hinge pin.

9. The system according to claim 8 wherein the means to adjustably attach to the base plate is a rotatable threaded fastener held contiguous to the door jamb side of the base plate by a stepped aperture and a threaded aperture in the second adjustable plate of the adjustable hinge assembly
whereby the fastener may be rotated clock wise and counter clockwise to adjust the space between the base plate and the second adjustable plate in order to rotationally to adjust the door with the door jamb.

10. The system according to claim 1 wherein the adjustable feature for the middle swivel hinge assembly is comprised of:
a) a first and second essentially rectangular plate with a series of loops;
b) a threaded means in the hinge plate loops;
c) an externally threaded pin; and
d) a fastening means to removably lock the threaded pin in a set location in relation to the threaded hinge plate loops
whereby the threaded hinge pin may be rotated clock wise and counter clockwise to adjust the space between the loops of the first and the second adjustable plates in order to vertically to adjust the door.

11. The system according to claim 10 wherein the threaded means in the hinge plate loops is a threaded insert that fits within the loops.

12. The system according to claim 10 wherein the threaded means in the hinge plate loops is by integrally and internally threading the loops.

13. The system according to claim 10 wherein the threaded means in the hinge plate loops is by a capnut that removably locks and secures the threaded pin in a fixed location.

14. An adjustable door hinge system made of durable materials for mounting a door to a door jamb comprised of:
A) a simple top adjustable hinge assembly and a simple bottom adjustable hinge assembly each with adjustable features comprised of:
1) a base plate with a means to attach to the door jamb and
2) a two part hinged adjustable assembly of essentially two rectangular plates and each with a series of loops for a pin; the first plate with a means to attach to the door; the second plate with a means to adjustably attach to the base plate; and the two plates rotationally connected by the hinge plate loops and a hinge pin;
B) a middle swivel hinge assembly comprised of:
1) a first and second essentially rectangular plate with a series of loops;
2) a threaded means in the hinge plate loops;
3) an externally threaded pin; and
4) a fastening means to removably lock the threaded pin in a set location in relation to the threaded hinge plate loops; and
C) a means to connect the hinge assemblies to the door and the door jamb
whereby the unique features of the hinges permit the door to be rotationally and vertically adjusted within the door jamb to permit smooth and easy operation of the door.
